(19) United States
(12) Patent Application Publication
(10) Pub. No.: US 2017/0372279 A1
(43) Pub. Date: Dec. 28, 2017

(54) PREDICTIVE DETERMINATION AND PROCESSING OF RESOURCES OVER A DISTRIBUTED NETWORK

(71) Applicant: BANK OF AMERICA CORPORATION, Charlotte, NC (US)

(72) Inventors: Amit Kumar, Alpharetta, GA (US); Deborah A. Copes, Wethersfield, CT (US)

(21) Appl. No.: 15/195,007

(22) Filed: Jun. 28, 2016

(51) Int. Cl. G06Q 20/10; G06K 9/18; G06Q 20/38; G06Q 20/40

(52) U.S. Cl. CPC G06Q 20/10; G06Q 20/405; G06K 9/18; G06Q 20/385

(57) ABSTRACT

Embodiments of the present invention provide for improving the capacity, speed, confidence, and efficiency of processing systems for processing resources instruments by utilizing predictive determination of resource instrument information from one or more resource instruments. As such, while processing resource instruments, instead of capturing all of the resource instrument information from the resource instruments, the present invention utilizes predictive determination of the resource instrument information in order to reduce the processing capacity needed, the processing run-times, processing errors, and unnecessary processing depending on the resource instruments and/or resource processing channels being used.

### FIELD

The present invention relates to utilizing predictive determination of resource information on resource instruments to improve processing speeds, confidence, and efficiency for processing the resource instruments over a distributed network of systems.

### BACKGROUND

Resource allocation and transfer between entities can be a complicated process. Entities are limited in resource processing by the capacity, speed, confidence, and efficiency of the processing systems and processes implementing the processing systems. Large volumes of resources may be presented for processing on any given day at any given time. As such, improved systems and processes are needed to handle processing of resource instruments.

### BRIEF SUMMARY

Embodiments of the present invention provide for improving the capacity, speed, confidence, and efficiency of processing systems for processing resources instruments by utilizing predictive determination of resource instrument information from one or more resource instruments. As such, while processing resource instruments, instead of capturing all of the resource instrument information from the resource instruments, the present invention utilizes predictive determination of the resource instrument information in order to reduce the processing capacity needed, the processing run-times, processing errors, and unnecessary processing depending on the resource instruments and/or resource processing channels being used.

Embodiments of the invention relate to systems, methods, and computer program products for improving processing of resource instruments by utilizing predictive determination of resource information from resource instruments through a distributed network of systems. The invention includes electronically receiving a user authentication request to identify a user, wherein the user authentication request includes a user identifier. The invention further comprises electronically identifying the user based on the user identifier. The invention also electronically receives a resource transfer request for one or more resource transfers associated with one or more resource instruments. The invention further comprises electronically automatically determining a predictive portion of resource instrument information associated with the one or more resource instruments, wherein the predicative portion of resource instrument information is based on the user identifier. The invention also electronically receives a captured portion of resource instrument information associated with the one or more resource instruments, wherein the captured portion of resource instrument information is captured from an information capture device. The invention further includes electronically processing the one or more resource transfers for the one or more resource instruments utilizing the predictive portion of resource instrument information and the captured portion of resource instrument information.

In further accord with aspects of the invention, processing speed, processing confidence, and processing efficiency is improved by utilizing the predictive portion of resource instrument information and reducing the resource instrument information that requires capturing.

In other aspects of the invention, the predictive portion of resource instrument information includes a payee name for the one or more resource instruments, and wherein the payee name is assumed to be the user based on the user identifier.

In still other aspects of the invention, the captured portion of the resource instrument information is captured from the one or more resource instruments using an image capture device to capture one or more images of the one or more resource instruments and utilizing an image analysis application to identify characters in the one or more images.

In yet other aspects of the invention, the captured portion of the resource instrument information is captured from the one or more resource instruments using an optical character recognition device and an optical character recognition application to identify characters from the one or more resource instruments.

In further accord with aspects of the invention, the invention comprises electronically determining one or more payor entities from the one or more resource instruments, wherein the one or more payor entities are determined from the captured portion of resource instrument information from the one or more resource instruments. The invention also comprises electronically determining when the one or more payor entities are different from an entity holding a resource pool of the user. The invention further comprises electronically processing the one or more resource instruments by archiving the one or more images of the one or more resource instruments without a payee name and without sending the one or more images for manual keying of the payee name when the one or more payor entities are different from the entity holding the resource pool of the user.

In other aspects of the invention, the invention comprises electronically determining one or more payor entities from the one or more resource instruments, wherein the one or more payor entities are determined from the captured portion of resource instrument information. The invention further comprises electronically determining when the one or more payor entities are the same as an entity holding a resource pool of the user. The invention also comprises electronically processing the one or more resource instruments internally without archiving the one or more images of the one or more resource instruments when the one or more payor entities are the same as the entity holding the resource pool of the user.

In still other aspects of the invention, the user authentication request, the one or more resource transfer requests, and the captured portion of resource instrument information are received from a user device with an image capture device that captures one or more images of the one or more resource instruments and the one or more images are captured without capturing a payee name for the one or more resource instruments.

In yet other aspects of the invention, the user authentication request, the one or more resource transfer requests, and the captured portion of resource instrument information are received from an entity processing system with an image capture device that captures one or more images of the one or more resource instruments and the one or more images are captured without capturing a payee name for the one or more resource instruments.

In further accord with aspects of the invention, the user authentication request, the one or more resource transfer requests, and the captured portion of resource instrument information are received from an automated processing system with an image capture device that captures one or more images of the one or more resource instruments and the one or more images are captured without capturing a payee name for the one or more resource instruments.

The features, functions, and advantages that have been discussed may be achieved independently in various embodiments of the present invention or may be combined with yet other embodiments, further details of which can be seen with reference to the following description and drawings.

### BRIEF DESCRIPTION OF THE DRAWINGS

Having thus described embodiments of the invention in general terms, reference will now be made the accompanying drawings, wherein:

FIG. 1 presents a block diagram illustrating a resource instrument processing environment, in accordance with aspects of the invention;

FIG. 2 presents a flow diagram for a process for predictive determination and processing of resource instruments, in accordance with aspects of the invention;

FIG. 3 presents a resource instrument, in accordance with aspects of the invention; and

FIG. 4 presents an image of a resource instrument, in accordance with aspects of the invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Where possible, any terms expressed in the singular form herein are meant to also include the plural form and vice versa, unless explicitly stated otherwise. Also, as used herein, the term “a” and/or “an” shall mean “one or more,” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.” Furthermore, when it is said herein that something is “associated with” something else, it may be associated with one or more other things as well. In other words, unless expressly indicated otherwise, as used herein “associated with” means “associated at least in part with” or “associated at least partially with.” Like numbers refer to like elements throughout.

Embodiments of the present invention provide for improving the capacity, speed, confidence, and efficiency of processing systems for processing resources instruments by utilizing predictive determination of resource instrument information from one or more resource instruments. As such, while processing resource instruments, instead of capturing all of the resource instrument information from the resource instruments, the present invention utilizes predictive determination of the resource instrument information in order to reduce the processing capacity needed, the processing run-times, processing errors, and unnecessary processing depending on the resource instruments and/or resource processing channels being used.

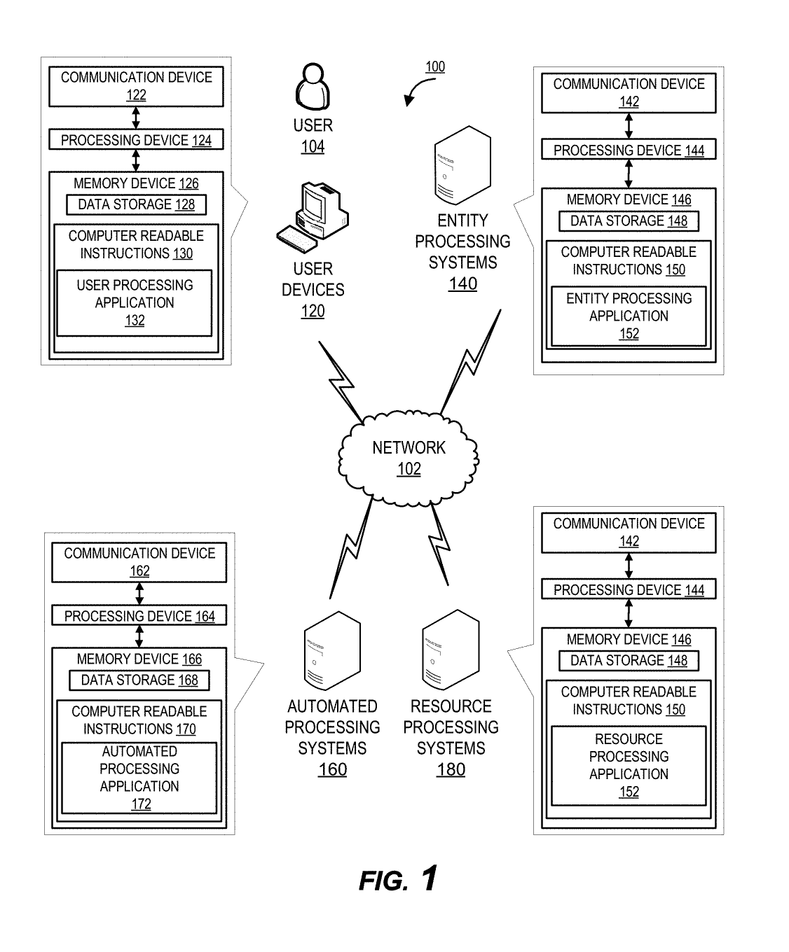

FIG. 1 illustrates a resource processing system environment 100, in accordance with embodiments of the invention. As illustrated in FIG. 1, the environment 100 includes one or more users 104 (e.g., a plurality of users 104) associated with one or more user devices 120, one or more entity systems 140, and/or one or more automated processing systems 160. As will be described herein, the resource instruments may be presented for processing by one or more users 104 using the one or more user devices 120, the one or more entity systems 140, and/or the one or more automated processing systems 160. As such, as described herein a user (e.g., employee, agent, one or more associates, contractors, sub-contractors, third-party representatives, individuals or the like) may affiliated or unaffiliated with an entity. A user 104 may utilize the user device 120, the entity processing systems 140 (e.g., individually or through an associate), the automated processing systems 160, or the like to present the resource instruments and/or resource instrument information described herein to the resource processing systems 180 for processing.

As such, as illustrated in FIG. 1, the one or more user devices 120 are operatively coupled to the one or more entity systems 140, the one or more automated processing systems 160, and/or the one or more resource allocation systems 180, or other systems through a network 102, as will be described in detail herein. The network 102 may be a global area network (GAN), such as the Internet, a wide area network (WAN), a local area network (LAN), or any other type of network or combination of networks. The network 102 may provide for wireline, wireless, or a combination of wireline and wireless communication between systems, servers, components, and/or devices on the network 102. It should be understood these devices and systems may be directly or indirectly operatively coupled together depending on the communication occurring between the devices and systems.

As illustrated in FIG. 1, the user 104 may access or utilize the one or more user devices 120 to submit resource instruments for processing to the resource processing systems 180. The one or more user devices 120 may be a desktop, laptop, tablet, mobile device (e.g., smartphone device, or other mobile device), or any other type of computer that generally comprises one or more communication devices 122, one or more processing devices 124, and one or more memory devices 126. As used herein, the term “processing device” or “processor” generally includes circuitry used for implementing the communication and/or logic functions of a particular system. For example, a processing device 124 may include a digital signal processor component, a microprocessor component, and various analog-to-digital converters, digital-to-analog converters, and other support circuits and/or combinations of the foregoing. Control and signal processing functions of the system are allocated between these processing components according to their respective capabilities. The processing device 124 may include functionality to operate one or more software programs based on computer-readable instructions 130 thereof, which may be stored in the memory device 126.

The one or more processing devices 124 of the one or more user devices 120 are operatively coupled to the one or more communication devices 122, and the one or more memory devices 126. The one or more processing devices 124 use the one or more communication devices 122 to communicate with the network 102 and other devices on the network 102, such as, but not limited to, the one or more entity systems 140, the one or more automated processing systems 160, the one or more resource transfer systems 180, and/or other systems. The one or more communication devices 122 generally comprise a wireless transceiver, modem, server, electrical connection, or other component for electronically communicating with (e.g., sending or receiving information to and from) other devices on the network 102. The one or more communication devices 122 may further include an interface that accepts one or more network interface cards, ports for connection of network components, Universal Serial Bus (USB) connectors, and/or the like. Moreover, the one or more communication devices 122 may include a keypad, keyboard, touch-screen, touchpad, microphone, mouse, joystick, other pointer component, button, soft key, and/or other input/output component(s) for communicating with the users 104.

In some aspects of the invention the one or more user devices 120 may further include an information capture device (e.g., an image capture device, such as a camera, a scanner, or the like information capture device) that is operatively coupled to the one or more processing devices 124. For example, an image capture device may be utilized to capture an image of, and/or capture resource instrument information from, the resource instruments, and the one or more processing devices 124 and the one or more communication devices 122 may be utilized to communicate the image, and/or resource instrument information associated therewith, to the other systems, such as but not limited to the one or more resource processing systems 180.

As illustrated in FIG. 1, the one or more user devices 120 may have computer-readable instructions 130 stored in the one or more memory device 126, which in one embodiment includes the computer-readable instructions 130 of a user processing application 132. In some embodiments, the user processing application 132 allows the one or more users 104 to capture images of, and/or resource instrument information from, the resource instruments, and send the resource instrument information for processing with the one or more resource processing systems 180, as will be discussed in further detail herein. In one aspect of the invention a user 104 (e.g., individual user) may capture the resource instrument information from resource instruments using a user device 120 in order to provide the resource instrument information to the one or more resource processing systems 180 for processing resource transfers, as will be described herein.

Also illustrated in FIG. 1, the one or more entity systems 140 generally comprise one or more communication devices 142, one or more processing devices 144, and one or more memory devices 146. The one or more processing devices 144 are operatively coupled to the one or more communication devices 142 and the one or more memory devices 146. The one or more processing devices 144 use the one or more communication devices 146 to communicate with the network 102 and other devices on the network 102, such as, but not limited to, the one or more user devices 120, the one or more automated processing systems 160, the one or more resource transfer systems 180, and/or other systems. The one or more communication devices 142 generally comprise a wireless transceiver, modem, server, electrical connection, electrical circuit, or other component for electronically communicating with (e.g., sending or receiving information to and from) other devices on the network 102. The one or more communication devices 142 may further include an interface that accepts one or more network interface cards, ports for connection of network components, Universal Serial Bus (USB) connectors, and/or the like.

In some aspects of the invention the one or more entity systems 140 may further include an information capture device (e.g., an image capture device, such as a camera, a scanner, or the like information capture device) that is operatively coupled to the one or more processing devices 144. For example, the image capture device may be utilized to capture an image of, and/or capture resource instrument information from, the resource instruments, and the one or more processing devices 144 and one or more communication devices 142 may be utilized to communicate the image, and/or resource instrument information associated therewith, to the other systems, such as but not limited to the one or more resource processing systems 180.

As further illustrated in FIG. 1, the one or more entity systems 140 comprise computer-readable instructions 150 stored in the one or more memory devices 146, which in one embodiment includes the computer-readable instructions 150 of an entity processing application 152. In some embodiments, the one or more memory devices 146 include data storage 148 for storing data related to the one or more entity systems 140, including, but not limited to, data created, accessed, and/or used by the entity processing application 152. In some embodiments, the entity processing application 152 may receive resources instruments from the user 104 and process the resource instruments by capturing images, and/or resource instrument information from, the resource instruments, and send the resource instrument information for processing with the one or more resource processing systems 180. In one aspect of the invention a user 104 (e.g., individual user, or entity associate) may capture resource instrument information from resource instruments using the entity systems 140 in order to provide the resource instrument information to the one or more resource processing systems 180 for processing the resource transfers, as will be described herein.

Also illustrated in FIG. 1, the one or more automated processing systems 160 generally comprise one or more communication devices 162, one or more processing devices 164, and one or more memory devices 166. The one or more processing devices 164 are operatively coupled to the one or more communication devices 162 and the one or more memory devices 166. The one or more processing devices 164 use the one or more communication devices 166 to communicate with the network 102 and other devices on the network 102, such as, but not limited to, the one or more user devices 120, the one or more entity systems 140, the one or more resource transfer systems 180, and/or other systems. The one or more communication devices 162 generally comprise a wireless transceiver, modem, server, electrical connection, electrical circuit, or other component for electronically communicating with (e.g., sending or receiving information to and from) other devices on the network 102. The one or more communication devices 162 may further include an interface that accepts one or more network interface cards, ports for connection of network components, Universal Serial Bus (USB) connectors, and/or the like.

In some aspects of the invention the one or more automated processing systems 160 may further include an information capture device (e.g., an image capture device, such as a camera, a scanner, or the like information capture device) that is operatively coupled to the one or more processing devices 164. For example, the image capture device may be utilized to capture an image of, and/or capture resource instrument information from, the resource instruments, and the one or more processing devices 164 and the one or more communication devices 162 may be utilized to communicate the image, and/or resource instrument information associated therewith, to the other systems, such as but not limited to the one or more resource processing systems 180.

As further illustrated in FIG. 1, the one or more automated processing systems 160 comprise computer-readable instructions 170 stored in the memory device 176, which in one embodiment includes the computer-readable instructions 170 of an automated processing application 172. In some embodiments, the one or more memory devices 166 includes data storage 168 for storing data related to the one or more automated processing systems 160, including, but not limited to, data created, accessed, and/or used by the automated processing application 172. In some embodiments, the automated processing application 172 may receive resource instruments from the user 104 (e.g., individual user) and process the resource instruments by capturing images, and/or resource instrument information from, the resource instruments, and send the resource instrument information for processing with the one or more resource processing systems 180. In one aspect of the invention a user 104 (e.g., individual user) may provide the resource instruments to an automated processing system 160, which captures information from the resource instruments in order to provide the resource instrument information to the one or more resource processing systems 180 for processing the resource transfers, as will be described herein.

Also illustrated in FIG. 1, the one or more resource processing systems 180 generally comprises one or more communication devices 182, one or more processing devices 184, and one or more memory devices 168. The one or more processing devices 184 are operatively coupled to the one or more communication devices 182 and the one or more memory devices 186. The one or more processing devices 184 use the one or more communication devices 186 to communicate with the network 102 and other devices on the network 102, such as, but not limited to, the one or more user devices 120, the one or more entity systems 140, the one or more automated processing systems 160, or other like systems. The one or more communication devices 182 generally comprise a wireless transceiver, modem, server, electrical connection, electrical circuit, or other component for electronically communicating with (e.g., sending or receiving information to and from) other devices on the network 102. The one or more communication devices 182 may further include an interface that accepts one or more network interface cards, ports for connection of network components, Universal Serial Bus (USB) connectors, and/or the like.

As further illustrated in FIG. 1, the one or more resource transfer systems 180 comprise computer-readable instructions 190 stored in the one or more memory devices 186, which in one embodiment includes the computer-readable instructions 190 of the resource processing application 192. In some embodiments, the one or more memory devices 186 include data storage 188 for storing data related to the one or more resource processing systems 180, including, but not limited to, data created, accessed, and/or used by the resource processing application 192. In some embodiments, the resource processing application 192 receives images and/or resource instrument information from the resource instruments, which were captured by the one or more user devices 120, the one or more entity processing systems 140, and/or the one or more automated processing systems 160 and utilizes at least a portion of the resource instrument information to process the resource transfers, as will be described herein.

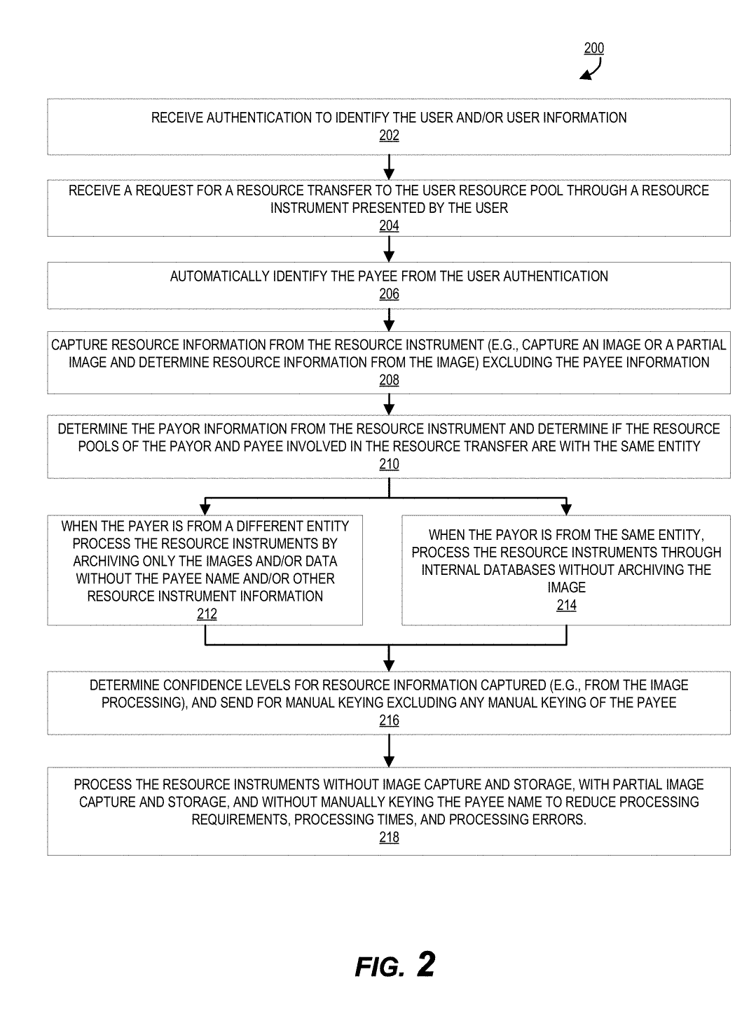

FIG. 2 presents a flow diagram for illustrating a process for predictive determination and processing of one or more resource instruments for one or more resource transfers. Block 202 of FIG. 2 illustrates that user authentication is received, which is utilized to determine the identity of the user 104. In some aspects of the invention the user authentication is the user 104 providing one or more user identifiers that are used to determine the identity of the user 104, a resource pool (e.g., account, or the like) associated with the user 104, and/or other information about the user 104. In some aspects of the invention the user identifier may be received from the user 104 through the user device 120. For example, a user 104 may log into a user processing application 132 (e.g., an online banking account application, or other like application) through the use of a user device 120 (e.g., mobile phone, or the like). In this aspect of the invention the user 104 may provide one or more user identifiers (e.g., user ID and password, location information provided by a location determining device in the user device 120, security question, security characters, touchscreen movements, facial recognition, body gestures, identification key, or other first, second, or more user identifiers) to log into the user processing application 132.

In other aspects of the invention the user identifier may be received from the user 104 or from an entity user (e.g., an associate) through the entity processing systems 140. For example, a user 104 may present a user identifier, such as a resource pool number (e.g., account number, such as through swiping a card) and/or a pin number (e.g., a pin number for the account) directly, or through an entity user (e.g., an associate), to an entity processing application 152 (e.g., teller application) at an entity (e.g., an entity branch, or the like). In some examples, the user 104 may provide a debit card, near field communication through the user device 120, or other user identifier to a teller system at a financial institution branch. In this way the entity user (e.g., associate, teller, or the like) may identify the user 104 and/or send the user identifier to the resource processing systems 180.

In other aspects of the invention the user identifier may be received from the user 104 through the automated processing systems 160. For example, the user identifier may be received when a user 104 presents the user identifier, such as a resource pool number (e.g., account number, such as through swiping a card) and/or a pin number (e.g., a pin number for the account) to an automated processing application 172 through an automated processing system 160 (e.g., an automated teller machine (ATM), or the like). In some examples of the invention the user 104 may provide a debit card, near field communication through the user device 120, or other identifying information to an ATM (or other kiosk, remote capture device, or the like). Regardless of the processing channel (e.g., the user device 120, the entity processing systems 140, the automated processing systems 160, or the like) through which the user identifier for authentication is received, the system interacting with the user 104 may use the user identifier to determine the identity of the user, user information, the user resource pool, or the like in order to proceed with processing resource transfer requests from the user 104, as described in further detail below.

Block 204 of FIG. 2 illustrates that after the user 104 is authenticated, a request for one or more resource transfers are received. The request may be received by the resource processing systems 180 from the user device 120, from the entity processing systems 140, from the automated processing systems 160, or other like systems. In one aspect of the invention the request may be a request to transfer resources into the resource pool of the user 104. In some aspects of the invention the request may be a request to deposit resource amounts from one or more resource instruments (e.g., checks, or other negotiable instruments) into a user's resource pool (e.g., user account). For example, the user 104 may deposit one or more checks (e.g., a plurality of checks) into the user account. The deposit of the resources from the resource instruments may be made through the user device 120 (e.g., user mobile phone, or the like), the entity processing systems 140 (e.g., teller at a financial institution, kiosk, or the like), the automated processing systems 160 (e.g., an ATM, or other remote capture system), and/or the like.

In some aspects of the invention, the system determines a predictive portion of resource instrument information from the plurality of resource instruments based on the user identifier received. For example, FIG. 2 illustrates in block 206, that after receiving the request for the one or more resource transfers using the one or more resource instruments, the system may make a predictive determination (e.g., assumption, or the like) that the each of the resource instruments being presented by the user 104 list the user 104 as the payee. For example, the system may predict that all of the physical checks being deposited by the user 104 are in fact made out to the user (e.g., assume that the user 104 is the payee). As such, by predicting that the user 104 that was previously authenticated (e.g., from the user identifier) is the payee of the one or more resource instruments being presented, the resource processing systems 180 do not have to capture any information from the one or more resource instruments regarding the payee. Consequently, the payee information that is typically captured from the one or more resource instruments is determined by the authentication of the user 104 and not by capturing payee information from the one or more resource instruments (e.g., the physical checks). Therefore, capturing an image of the physical resource instrument and determining the payee name using image character recognition, using optical character recognition to determine the payee name from the physical resource instrument, determining a confidence level of the determination of the payee name, and/or any manual keying of the payee name is not needed using the present invention.

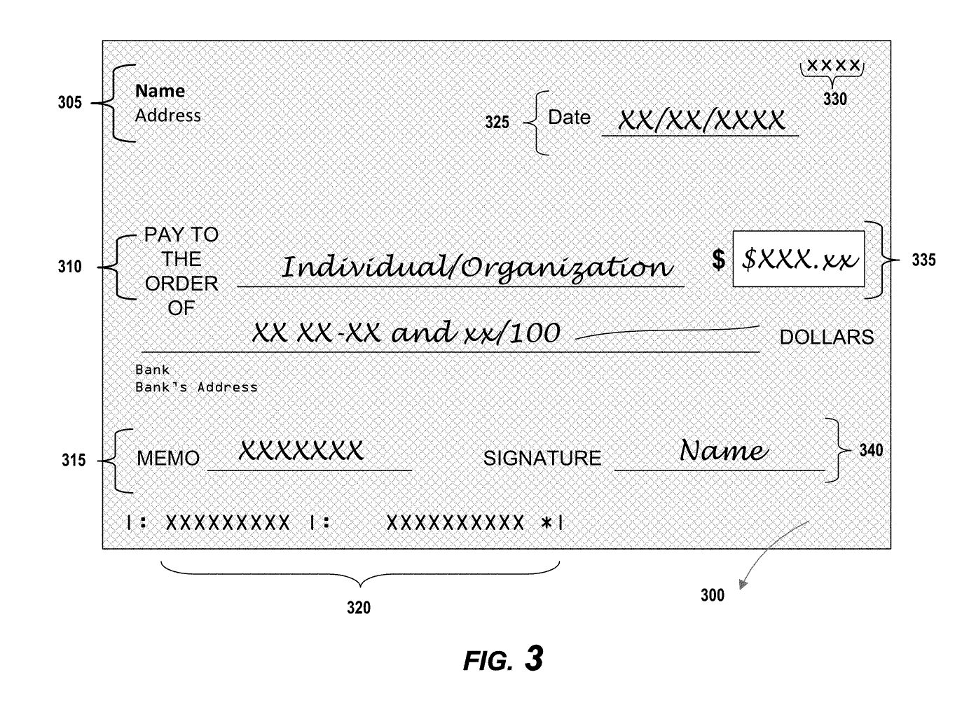

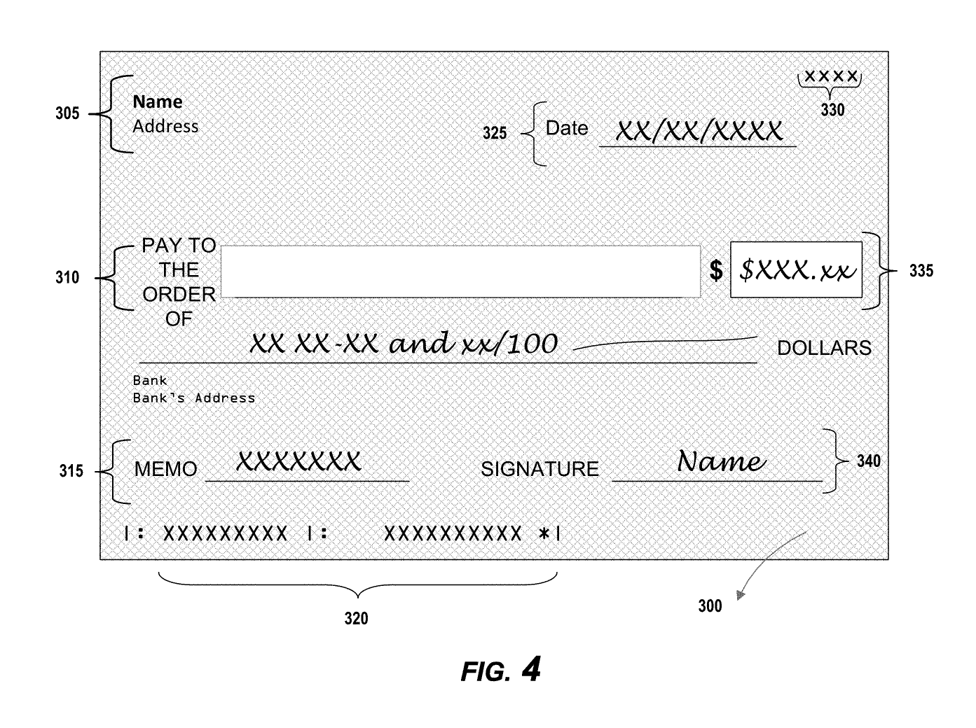

As previously described with respect to block 206 in FIG. 2, the one or more processing systems described herein may make a predictive determination of the check information that is usually captured from the physical checks. As such, not only is the manual keying not required for the check information that is predicted, but the information does not need to be captured from a physical check. For example, as illustrated with respect to FIGS. 3 and 4, the one or more systems described herein are not required to capture all of the information from the resource instruments. As illustrated in FIGS. 3 and 4, in one aspect of the invention the payee 310 may not be captured by the one or more systems. For example, if the information capture device is an image capture device, the image captured from the physical check may not include the portion illustrating the payee 310. Alternatively, the image capture device may capture the entire image of the check; however, an application associated with the image capture device may negate (e.g., blur-out, remove, or the like) a portion of the image in order to save space on the memory devices on which the images may be stored for archiving. Alternatively, if the capture device is an optical character recognition device, the application associated with the device may not capture a portion of the check that includes the payee 310. As such, it should be understood by not capturing the payee information (e.g., in an image of the resource instrument, in scanning the resource instrument, or in another capture process) the processing speeds are improved (e.g., the time it takes to capture this information is not needed), the processing confidence is improved (e.g., the user identity is more accurate from the user authentication than from the information captured form the resource instrument), the processing confidence is improved (e.g., confidence scoring and manual keying of the captured information is not needed), and the processing capacity needed is reduced (e.g., the memory storage for archiving information is not needed).

The systems described herein also capture a portion of the resource instrument information from the one or more resource instruments using an information capture device, such as image capture device and digital character recognition application, an optical character recognition device and optical character recognition application, or other like information capture device in the user device 102, the entity processing systems 140, or the automated processing systems 160. Block 208 of FIG. 2 illustrates that the resource information is captured from the one or more resource instruments presented by the user 104. In one aspect of the invention the resource instrument information is received by the resource processing systems 180 after being captured from the user device 120, from the entity processing systems 140, from the automated processing systems 160, or other like systems. In some aspects of the invention the resource instruments are checks (or other negotiable instruments) and resource instrument information is information located on the checks.

FIG. 3 provides an example of a physical resource instrument (e.g., check) that may be presented for processing, while FIG. 4 provides an example of an image of the physical resource instrument for which certain portions of the image are not captured or are negated (e.g., stricken, removed, not captured, or the like) from the image in order to improve the processing. FIG. 3 illustrates the entire front face of a check, while the image of the physical check in FIG. 4 may comprise an image of the entire check, a thumbnail version of the image of the check, individual portions of the front of the check, or the like. Check 300 comprises resource instrument information (e.g., check information), wherein the check information comprises contact information 305 (payor address and name), the payee 310 (e.g., payee name handwritten or typed), the memo description 315 (e.g., handwritten or typed), the account number and routing number 320 associated with the payor, the date 325 (e.g., handwritten or typed), the check number 330, the amount of the check 335 (e.g., handwritten or typed), the signature 340 (e.g., handwritten or typed), or the like. During typical processing optical character recognition, image character recognition, or the like is used to recognize all of the check information. However, since some of the check information is handwritten (or in some cases even when the information is typed) the information may be difficult to read. As such a confidence level is typically determined and assigned to the check information captured from the check (e.g., regardless of how the check information is captured). As such, if the confidence score of a particular piece of the check information (e.g., character, word, phrase, or the like) is below a threshold level, an image of the check, and potentially the captured check information, is sent to an associate for manual keying. It should be understood that when the check is sent for manual keying the associate will examine the image of the check (and potentially the captured information), and manually type in the check information that scored below the confidence level. This process is time consuming and expensive.

With respect to FIGS. 3 and 4, it will be understood that any type of resource instrument image may be received. Exemplary check images include PDF files, scanned documents, digital photographs, and the like. However, when the resource instrument is not a check, the resource instrument images comprise indicia that includes various types of resource instrument information. The resource instrument information may include dates of the resource instruments, terms of the resource instruments, time period that the resource instruments are in effect, identification of parties associated with the resource instruments (e.g., in some cases excluding the payee information), payor information, obligations of parties to a contract, purchase amount, loan amount, consideration for a contract, representations and warranties, product return policies, product descriptions, resource instruments numbers, document identifiers, resource pool numbers, merchant codes, file identifiers, source identifiers, and the like.

Returning to FIG. 2, as illustrated by block 208 an information capture device (e.g., image capture device, optical character recognition device, or other like captured device) may capture resource instrument information from the one or more resource instruments. For example, as discussed above an image of the check 300 may be captured and information may be determine from the image of the check. The systems and applications discussed may be utilized to capture the resource instrument information from the resource instruments, such as the check information excluding the payee information. Alternatively, the information may be captured by the systems and applications described herein, and thereafter transferred to the resource processing systems 180 for determining the resource instrument information for processing. For example, an image of the one or more checks (or other resource instruments) may be transferred to the resource processing systems 180, and the resource processing systems 180 may capture information from the images of the one or more checks for processing.

In some aspects of the invention the resource instrument information may be captured by the user 104 through the use of an information capture device within the user device 120, the entity processing systems 140, or the automated processing systems 160. In one aspect of the invention the user device 120 may include a camera device (or other image capture device) that is used to capture an image of the one or more of the resource instruments (e.g., checks, or other negotiable instruments). In some aspects of the invention the image capture device may only capture particular portions of the resource instruments. For example, the user processing application 132 in the user device 120 may allow the image capture device to take a picture and capture an image of the entire resource instrument (e.g., the entire check), but may negate (e.g., block-out, remove, blur, strike, or the like) sections of the image related to information that is not needed (e.g., the payee name) before the image is saved for processing.

In other aspects of the invention the entity processing systems 140 and/or the automated processing systems may include a camera device (or other image capture device) that is used to capture an image of the one or more of the resource instruments (e.g., checks, or other negotiable instruments). In some aspects of the invention the image capture device may only capture particular portions of the resource instruments. For example, the entity processing systems 140 and/or the automated processing systems 160 may allow the image capture device to take a picture of the entire resource instrument (e.g., the entire check), but may negate (e.g., block out, strike, blur, remove, or the like) sections of the image related to information that is not needed (e.g., the payee name) before the image is saved for processing.

Regardless of the system that captures the resource instrument information for processing, the resource instrument information may be stored in a datastore as metadata. In some aspects, the portions of the resource instrument information may be stored in the datastore individually. In other embodiments, multiple portions of the resource instrument information may be stored in the datastore together. In some examples, the one or more resource instrument images may comprise the entire front side of a resource instrument, the entire the back side of a resource instrument, or any partial portions within the front (e.g., without the payee name) or back of the resource instrument. In cases where there are several resource instruments piled into a stack, the multiple resource instrument images may include, for example, at least a portion of each of the sides of the resource instruments in the stack. In this way, any text, character, or other data provided on any side of the resource instruments in the stack may be captured (except for the payee name). It should be understood that in some aspects of the invention, the processing systems (120, 140, 160, and 180) may not only negate the payee name, but may only also negate (e.g., not capture, blur, remove, strike, or the like) the payee endorsement signature (e.g., may determine that the endorsement signature exists, but not actually capture the endorsement signature).

Block 210 of FIG. 2 illustrates that the payor information is determined from the resource instrument information captured. The payor information may include the payor name, the payor resource pool number (e.g., payor account), or other payor information that may be captured from the resource instruments, or otherwise derived from the payor information captured from the resource instruments. Moreover, based on the identity of the payor, a determination is made regarding the payee and the payor, and whether or not the resource pools associated with each in the present resource transfers are with the same entity (e.g., same financial institution) to determine additional processing of the one or more resource transfers.

As such, block 212 in FIG. 2 illustrates that the when the payor is from a different entity, the one or more resource instruments may be processed by archiving the images and/or data associated with the one or more resource transfers, except for the payee name. For example, the images archived for resource transfers may include the images with the payee name negated (e.g., removed, blacked or whited out, blurred, stricken, or otherwise not captured) in the image file. As such, because only a portion of the image of the resource instrument is used for processing and/or archiving the processing speed may be improved, and/or the memory needed to store the image may be reduced. Moreover, because the payee name is predicted based on the user authentication, no confidence scoring or manual keying of the payee name is required. As such, the processing speed, confidence, and efficiency may also be improved.

Block 214 of FIG. 2 further illustrates that when the payor is from the same entity as the payee, the one or more resource instruments may be processed internally with internal databases without archiving the image (e.g., the entire image, or the like) of the one or more resource instruments and/or without manual keying of the payee name. As such in some aspects of the invention the image may be utilized to process the initial application; however, because the resource transfer is occurring between resource pools within the same entity (e.g., same financial institution) the entity does not need to archive an image of the resource instrument because the image does not need to be transferred to different entities for processing. As such, the capacity, processing speed, and efficiency may be improved because the images for resource transfers within the same entity (e.g., financial institution) do not require archiving.

Block 216 illustrates that for the portions of the resource instruments that are captured for processing, such as the amount of resources being transferred, the payor resource pool number (e.g., account number), memo, date, or the like, this information may be processed using traditional processes, such as by determining a confidence level for the captured information from the resource instruments. The confidence level determination may be needed on the handwritten portions of the resource instrument (e.g., that are not the payee name, endorsement signature, or the like). The confidence level may be compared to a threshold confidence level, and if it fails to meet the threshold confidence level, captured information and/or the captured image (e.g., excluding the payee name, the endorsement signature, or the like) may be sent for manual keying.

FIG. 2 further illustrates in block 218 that the resources instruments are processed without image capture and storage, with partial image capture and storage, and without manual keying for the payee name. As such, as discussed in block 212 when the payor and payee resource pools are at separate institutions, the modified images (images with the excluded payee name) are archived and sent for processing using the typical processing channels. However, as discussed in block 214, in some aspects of the invention when the payer and payee are at the same institution the modified images are used for processing, but are not archived. In other aspects of the invention, when the payor and payee are at the same institution, the modified images may be archived for internal processing, reporting, or other functions (e.g., presenting the images to the user in a resource transfer list in an online banking application).

Regardless of the use of the images during processing, processing the resource instruments described herein using a predictive portion of the resource instruments determined from the user authentication (e.g., the payee name) does not require determination of a confidence score and/or manual keying, and thus improves the processing of the resource instruments discussed herein. The processing described herein improves processing speed (e.g., the resource instruments can be processed faster), improves the processing confidence (e.g., the payee name is more accurate when determined from authentication than when it is read from physical negotiable instruments), improves the processing efficiency (e.g., the processors required to process the resource instruments are reduced because the processing is more efficient), and the capacity is improved (e.g., the memory storage needed is reduced by reducing the size of the image files that require archiving because of the negation of the payee name from the image files, and/or by reducing number of images that are archived). It should be understood that large entities (e.g., large financial institutions) may process approximately 15 million resource instruments daily (e.g., the number may be more or less depending on the size of the institution). The present invention may reduce the number of images needed for archiving to approximately half, or by 20, 30, 40, 50, 60, 70, or 80 percent, or any percentage range that falls within, outside, or overlapping these values. Moreover, the size of the image files (e.g., without the payee name) may be reduced by 1, 5, 10, 15, 20, 25, 30, 40, 50, 60 percent, or any percentage range that falls within, outside, or overlapping these values.

It should be understood that the process flows described herein include transforming the information sent and/or received from the applications of the different systems (e.g., internally or externally) from one or more data formats into a data format associated with the other applications and systems. There are many ways in which information is converted within the system environment 100. This may be seamless, as in the case of upgrading to a newer version of a computer program. Alternatively, the conversion may require processing by the use of a special conversion program, or it may involve a complex process of going through intermediary stages, or involving complex “exporting” and “importing” procedures, which may convert to and from a tab-delineated or comma-separated text file. In some cases, a program may recognize several data file formats at the data input stage and then is also capable of storing the output data in a number of different formats. Such a program may be used to convert a file format. If the source format or target format is not recognized, then at times a third program may be available which permits the conversion to an intermediate format, which can then be reformatted.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Any suitable transitory or non-transitory computer readable medium may be utilized. The computer readable medium may be, for example but not limited to, an electronic, magnetic, optical, electromagnetic, infrared, or semiconductor system, apparatus, or device. More specific examples of the computer readable medium include, but are not limited to, the following: an electrical connection having one or more wires; a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

In the context of this document, a computer readable medium may be any medium that can contain, store, communicate, or transport the program for use by or in connection with the instruction execution system, apparatus, or device. The computer usable program code may be transmitted using any appropriate medium, including but not limited to the Internet, wireline, optical fiber cable, radio frequency (RF) signals, or other mediums.

Computer-executable program code for carrying out operations of embodiments of the present invention may be written in an object oriented, scripted or unscripted programming language such as Java, Perl, Smalltalk, C++, or the like. However, the computer program code for carrying out operations of embodiments of the present invention may also be written in conventional procedural programming languages, such as the “C” programming language or similar programming languages.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

These computer-executable program code portions may also be stored in a computer-readable memory that can direct a computer or other programmable data processing apparatus to function in a particular manner, such that the code portions stored in the computer readable memory produce an article of manufacture including instruction mechanisms which implement the function/act specified in the flowchart and/or block diagram block(s).

The computer-executable program code may also be loaded onto a computer or other programmable data processing apparatus to cause a series of operational steps to be performed on the computer or other programmable apparatus to produce a computer-implemented process such that the code portions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

It will be understood that steps of the processes described herein may be performed in orders different than those illustrated in the flowcharts. In other words, the processes represented by the blocks of a flowchart may, in some embodiments, be in performed in an order other that the order illustrated, may be combined or divided, or may be performed simultaneously. It will also be understood that the blocks of the block diagrams illustrated, in some embodiments, merely conceptual delineations between systems and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

It should be understood that in some aspects of the invention the user described herein may be a customer, the entity may be a merchant, the resource transfer entity may be a financial institution, the resource pool may be accounts (e.g., a user account, a merchant account), the transfer may be associated with a transaction, and the resources may be funds that are allocated and transferred based on the parties entering into the transfer. It should be understood that the resources in other embodiments of the invention may be resources that are not funds, and instead are other types of resources that may be transferred between parties.

In accordance with embodiments of the invention, the terms “financial institution” and “financial entity” include any organization that processes financial transactions including, but not limited to, banks, credit unions, savings and loan associations, investment companies, stock brokerages, assess management firms, insurance companies and the like. In specific embodiments of the invention, use of the term “bank” is limited to a financial entity in which account-bearing customers conduct financial transactions, such as account deposits, withdrawals, allocations and the like.

In accordance with embodiments of the invention, an “account” is the relationship that a user has with an entity, such as a financial institution. Examples of accounts include a deposit account, such as a transactional account (e.g., a banking account), a savings account, an investment account, a money market account, a time deposit, a demand deposit, a pre-paid account, a credit account, a debit/deposit account, a non-monetary user profile that includes information associated with the user, or the like. The account is associated with and/or maintained by the entity. The term “resource” or “funds” includes forms of currency or payment stored by a financial institution in an account.

While certain exemplary embodiments have been described and shown in the accompanying drawings, it is to be understood that such embodiments are merely illustrative of, and not restrictive on, the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. A system for improving processing of resource instruments by utilizing predictive determination of resource information from resource instruments through a distributed network of systems, the system comprising:
one or more memory devices storing computer-readable code; and
one or more processing devices operatively coupled to the one or more memory devices, wherein the one or more processing devices are configured to execute the computer-readable code to:
electronically receive a user authentication request to identify a user, wherein the user authentication request includes a user identifier;
electronically identify the user based on the user identifier;
electronically receive a resource transfer request for one or more resource transfers associated with one or more resource instruments;
electronically automatically determine a predictive portion of resource instrument information associated with the one or more resource instruments, wherein the predicative portion of resource instrument information is based on the user identifier;
electronically receive a captured portion of resource instrument information associated with the one or more resource instruments, wherein the captured portion of resource instrument information is captured from an information capture device; and
electronically process the one or more resource transfers for the one or more resource instruments utilizing the predictive portion of resource instrument information and the captured portion of resource instrument information.

2. The system of claim 1, wherein processing speed, processing confidence, and processing efficiency is improved by utilizing the predictive portion of resource instrument information and reducing the resource instrument information that requires capturing.

3. The system of claim 1, wherein the predictive portion of resource instrument information includes a payee name for the one or more resource instruments, and wherein the payee name is assumed to be the user based on the user identifier.

4. The system of claim 1, wherein the captured portion of the resource instrument information is captured from the one or more resource instruments using an image capture device to capture one or more images of the one or more resource instruments and utilizing an image analysis application to identify characters in the one or more images.

5. The system of claim 1, wherein the captured portion of the resource instrument information is captured from the one or more resource instruments using an optical character recognition device and an optical character recognition application to identify characters from the one or more resource instruments.

6. The system of claim 1, wherein the one or more processing devices are configured to execute the computer-readable code to:
electronically determine one or more payor entities from the one or more resource instruments, wherein the one or more payor entities are determined from the captured portion of resource instrument information from the one or more resource instruments;
electronically determine when the one or more payor entities are different from an entity holding a resource pool of the user; and
electronically processing the one or more resource instruments by archiving the one or more images of the one or more resource instruments without a payee name and without sending the one or more images for manual keying of the payee name when the one or more payor entities are different from the entity holding the resource pool of the user.

7. The system of claim 1, wherein the one or more processing devices are configured to execute the computer-readable code to:
electronically determine one or more payor entities from the one or more resource instruments, wherein the one or more payor entities are determined from the captured portion of resource instrument information;
electronically determine when the one or more payor entities are the same as an entity holding a resource pool of the user; and
electronically processing the one or more resource instruments internally without archiving the one or more images of the one or more resource instruments when the one or more payor entities are the same as the entity holding the resource pool of the user.

8. The system of claim 1, wherein the user authentication request, the one or more resource transfer requests, and the captured portion of resource instrument information are received from a user device with an image capture device that captures one or more images of the one or more resource instruments and the one or more images are captured without capturing a payee name for the one or more resource instruments.

9. The system of claim 1, wherein the user authentication request, the one or more resource transfer requests, and the captured portion of resource instrument information are received from an entity processing system with an image capture device that captures one or more images of the one or more resource instruments and the one or more images are captured without capturing a payee name for the one or more resource instruments.

10. The system of claim 1, wherein the user authentication request, the one or more resource transfer requests, and the captured portion of resource instrument information are received from an automated processing system with an image capture device that captures one or more images of the one or more resource instruments and the one or more images are captured without capturing a payee name for the one or more resource instruments.

11. A method for improving processing of resource instruments by utilizing predictive determination of resource information from resource instruments through a distributed network of systems, the method comprising:
electronically receiving, by one or more processing devices, a user authentication request to identify a user, wherein the user authentication request includes a user identifier;
electronically identifying, by the one or more processing devices, the user based on the user identifier;
electronically receiving, by the one or more processing devices, a resource transfer request for one or more resource transfers associated with one or more resource instruments;
electronically automatically determining, by the one or more processing devices, a predictive portion of resource instrument information associated with the one or more resource instruments, wherein the predicative portion of resource instrument information is based on the user identifier;
electronically receiving, by the one or more processing devices, a captured portion of resource instrument information associated with the one or more resource instruments, wherein the captured portion of resource instrument information is captured from an information capture device; and
electronically processing, by the one or more processing devices, the one or more resource transfers for the one or more resource instruments utilizing the predictive portion of resource instrument information and the captured portion of resource instrument information.

12. The method of claim 11, wherein processing speed, processing confidence, and processing efficiency of the one or more processing devices is improved by utilizing the predictive portion of resource instrument information and reducing the resource instrument information that requires capturing.

13. The method of claim 11, wherein the predictive portion of resource instrument information includes a payee name for the one or more resource instruments, and wherein the payee name is assumed to be the user based on the user identifier.

14. The method of claim 11, wherein the captured portion of the resource instrument information is captured from the one or more resource instruments using an image capture device to capture one or more images of the one or more resource instruments and utilizing an image analysis application to identify characters in the one or more images.

15. The method of claim 11, wherein the captured portion of the resource instrument information is captured from the one or more resource instruments using an optical character recognition device and an optical character recognition application to identify characters from the one or more resource instruments.

16. The method of claim 11, further comprising:
electronically determining, by the one or more processing devices, one or more payor entities from the one or more resource instruments, wherein the one or more payor entities are determined from the captured portion of resource instrument information from the one or more resource instruments;
electronically determining, by the one or more processing devices, when the one or more payor entities are different from an entity holding a resource pool of the user; and
electronically processing, by the one or more processing devices, the one or more resource instruments by archiving the one or more images of the one or more resource instruments without a payee name and without sending the one or more images for manual keying of the payee name when the one or more payor entities are different from the entity holding the resource pool of the user.

17. The method of claim 11, further comprising:
electronically determining, by the one or more processing devices, one or more payor entities from the one or more resource instruments, wherein the one or more payor entities are determined from the captured portion of resource instrument information;
electronically determining, by the one or more processing devices, when the one or more payor entities are the same as an entity holding a resource pool of the user; and
electronically processing, by the one or more processing devise, the one or more resource instruments internally without archiving the one or more images of the one or more resource instruments when the one or more payor entities are the same as the entity holding the resource pool of the user.

18. The method of claim 11, wherein the user authentication request, the one or more resource transfer requests, and the captured portion of resource instrument information are received from:
a user device with an image capture device that captures one or more images of the one or more resource instruments and the one or more images are captured without capturing a payee name for the one or more resource instruments:
an entity processing system with an image capture device that captures one or more images of the one or more resource instruments and the one or more images are captured without capturing a payee name for the one or more resource instruments; or
an automated processing system with an image capture device that captures one or more images of the one or more resource instruments and the one or more images are captured without capturing a payee name for the one or more resource instruments.

19. A computer program product for improving processing of resource instruments by utilizing predictive determination of resource information from resource instruments through a distributed network of systems, the computer program product comprising at least one non-transitory computer-readable medium having computer-readable program code portions embodied therein, the computer-readable program code portions comprising:
an executable portion configured to electronically receive a user authentication request to identify a user, wherein the user authentication request includes a user identifier;
an executable portion configured to electronically identify the user based on the user identifier;
an executable portion configured to electronically receive a resource transfer request for one or more resource transfers associated with one or more resource instruments;
an executable portion configured to electronically automatically determine a predictive portion of resource instrument information associated with the one or more resource instruments, wherein the predicative portion of resource instrument information is based on the user identifier;
an executable portion configured to electronically receive a captured portion of resource instrument information associated with the one or more resource instruments, wherein the captured portion of resource instrument information is captured from an information capture device; and
an executable portion configured to electronically process the one or more resource transfers for the one or more resource instruments utilizing the predictive portion of resource instrument information and the captured portion of resource instrument information.

20. The computer program product of claim 19, wherein processing speed, processing confidence, and processing efficiency is improved by utilizing the predictive portion of resource instrument information and reducing the resource instrument information that requires capturing.
